(19) United States
(12) Patent Application Publication
(10) Pub. No.: US 2006/0254837 A1
(43) Pub. Date: Nov. 16, 2006

(54) Hybrid drive unit, and method of controlling a gear shift sequence in a manual shift transmission of a hybrid drive unit

(76) Inventors: Roland Andersson, Sollebrunn (SE); Mats Alakula, Kavlinge (SE)

Correspondence Address: OSTROLENK FABER GERB & SOFFEN, 1180 AVENUE OF THE AMERICAS, NEW YORK, NY, 100368403, US

(21) Appl. No.: 11/362,639

(22) Filed: Feb. 27, 2006

(30) Foreign Application Priority Data
Feb. 28, 2005 (SE) 0500445-2

(51) Int. Cl. B60L 8/00

(52) U.S. Cl. 180/65.3

(57) ABSTRACT

A hybrid drive unit comprising an internal combustion engine; a manual transmission; a manual clutch that can be engaged and disengaged, connected to the internal combustion engine and to a first input shaft of the transmission; at least one electric motor, connected to a second input shaft of the transmission and driveable from a chargeable electrical voltage source; and an electronic control unit connected to the electric motor. When manually upshifting and downshifting the transmission the electronic control unit is designed, without the use of a clutch between the electric motor and the transmission, to instantaneously make the second input shaft essentially torque-free by controlling the electric motor to brake and accelerate the second input shaft to a rotational speed suited to a higher and a lower, respectively, gear prior to active engagement of the relevant gear.

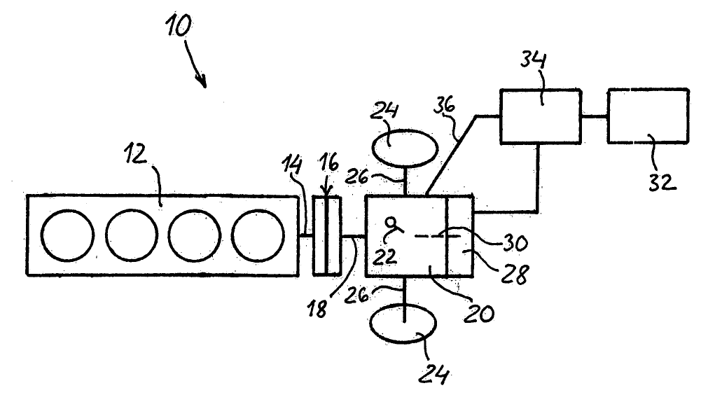

### REFERENCE TO RELATED APPLICATION

This application claim the benefit of the filing dated of Swedish Patent Application No: 0500445-2, filed Feb. 28, 2005, the disclosure of which is hereby incorporated by reference.

### BACKGROUND OF THE INVENTION

1. Technical Field

The present invention relates to a hybrid drive unit, which comprises a prime mover in the form of an internal combustion engine having an output shaft coupled to a crankshaft of the engine; a transmission manually operated by a gear shift device; a manual clutch that can be engaged and disengaged, connected to the output shaft from the internal combustion engine, and to a first input shaft of the transmission; at least one secondary drive motor in the form of an electric motor, connected to a second input shaft of the transmission and driveable from a chargeable electrical voltage source; and an electronic control unit connected to the electric motor, the hybrid drive unit having three selectable operating modes for propelling the vehicle forwards, that is to say a first mode operating solely with the internal combustion engine, a second mode with combined hybrid operation using the internal combustion engine and the electric motor, and a third mode operating solely with the electric motor, the electric motor in the first operating mode being useable as a generator for charging the electrical voltage source.

The invention also relates to a method of controlling a gearshift sequence in a manual shift transmission of a hybrid drive unit of the aforementioned type, in which the latter comprises a prime mover in the form of an internal combustion engine coupled to the manually operated transmission; a manually operated clutch that can be engaged and disengaged, connected to an output shaft from the internal combustion engine, and to a first input shaft of the transmission; and at least one secondary drive motor in the form of an electric motor, which is connected to a second input shaft of the transmission and is driveable from a chargeable electrical voltage source.

2. Related Art

Hybrid drives of the type specified in the introductory part are already known. A characteristic feature common to these drives is that for operation with just the electric motor a clutch is also required between the transmission and the electric motor, where it is intended to use the various gears of the transmission for forwards propulsion. In addition to this clutch, the clutch normally situated between the internal combustion engine and the transmission is also required, that is to say in all two separate clutches, which means an increase in the manufacturing cost and the space required for such a hybrid drive unit.

GB 2 358 006, for example, demonstrates various proposed power transmissions for hybrid drive vehicles in which, in the absence of a clutch between the electric motor and the transmission, use is made of just one single clutch between the internal combustion engine and the transmission. However, the electric motor in question here is not intended to propel the vehicle forwards independently with the facility for shifting gears, but is only intended either to be driven together with the internal combustion engine or independently when the vehicle is reversing, that is to say when no gear shifting function is necessary and therefore no clutch is needed either.

### SUMMARY OF THE INVENTION

An object of the present invention is to propose a hybrid drive unit of the aforementioned type, which for propelling a hybrid drive vehicle forwards allows substantially smooth manual gear shift both for individual operation of an internal combustion engine or an electric motor, as well as for a combined hybrid operation of the internal combustion engine and of the electric motor, with the aid of a single clutch.

To achieve this object the hybrid drive unit according to the invention is characterized by the features specified in the independent claim 1 below. By controlling the electric motor by means of an electronic control unit, when manually shifting the gear in all operating modes, so that the electric motor, to a sufficient extent, brakes or accelerates the second input shaft of the transmission to a rotational speed suited to a higher or lower gear, respectively, the input shaft can be made to instantaneously become essentially torque-free just prior to active engagement of the relevant gear of the transmission. In all operating modes this allows an essentially smooth gear shift sequence to be achieved without the need for a separate clutch between the electric motor and the transmission.

Further characteristic features of the hybrid drive unit according to the invention are specified in the dependent claims appended to claim 1.

Another object of the present invention is to propose a method of performing a substantially smooth gear shift sequence in a manual shift transmission in said three operating modes of a hybrid drive unit of the aforementioned type. To achieve this object the method according to the invention is characterized by the features specified in the independent claim 5.

Further characteristic features of the method according to the invention are set forth in the dependent claims appended to claim 5.

The invention is described in more detail below with reference to the drawing attached.

### BRIEF DESCRIPTION OF THE DRAWING

The FIGURE shows a schematic block diagram of a hybrid drive unit according to the present invention.

### DESCRIPTION OF PREFERRED EMBODIMENTS

In the drawing a hybrid drive unit according to the present invention is generally denoted by 10. In its basic construction the hybrid drive unit 10 comprises an internal combustion engine 12 of any type known in the art. The crankshaft (not shown) of the engine 12 is coupled by way of an output shaft 14 to a manually operated clutch 16 that can be engaged and disengaged, which may be of any suitable known type, such as an electromagnetic, hydraulic or friction clutch. The clutch 16 is furthermore connected to a first input shaft 18 of a multi-step gearbox or transmission 20, which can be manually operated by means of an operating device 22, for example a gear lever, steering wheel paddles, or the like. A pair of driving wheels 24 of the vehicle are each connected to the transmission 20 by way of a respective drive shaft 26. An electric motor 28, which is preferably of a compact disk-shaped type and is integrated with the transmission 20, is likewise connected to the transmission 20 by way of a schematically indicated second input shaft 30. The first and second input shafts 18 and 30 of the transmission 20 may be formed by a first and second end respectively of a common main shaft through the transmission 20 or may be comprised of separate shafts coupled to one another. The electric motor 28 may be supplied with current from a voltage source, such as a chargeable storage battery 32, via an electronic control unit 34.

The hybrid drive unit 10 in a known manner has three selectable operating modes for propelling the vehicle forwards, that is to say a first mode operating solely with the internal combustion engine 12, a second mode with combined hybrid operation using the internal combustion engine 12 and the electric motor 28, and a third mode operating solely with the electric motor 28. In the first aforementioned operating mode, when the electric motor 28 is not delivering any torque to the transmission 20, that is to say in pure internal combustion engine mode, the electric motor 28 may function as a generator for charging the storage battery 32.

According to the invention the electronic control unit 34 is designed to regulate the rotational speed and torque of the electric motor 28 in such a manner that electric motor 28 may control the rotational speed of the second input shaft 30 of the transmission 20 so that manual, substantially smooth upward and downward shifting of the transmission 20 can be performed without need for an additional clutch between the electric motor 28 and the transmission 20. Thus, controlling the electric motor 28 by means of an electronic control unit 34 in electric motor operation so that it brakes or accelerates the second input shaft 30 of the transmission 20 to a rotational speed suited to a higher or lower gear means that the input shaft 30 can be made to instantaneously become essentially torque-free just prior to active engagement of the relevant gear of the transmission 20. Parameters needed for the gearshift sequence may be fed from the transmission 20 to the control unit 34 in signal form via a lead 36. The arrangement according to the invention allows an essentially smooth gear shift sequence to be achieved in the electric motor operating mode without the aid of a separate clutch between the electric motor 28 and the transmission 20. This applies both in strict electric motor operation, when the clutch 16 is inoperative or disengaged, and in an interactive, combined operation of the internal combustion engine 12 and the electric motor 28. In the latter case the electric motor 28 can therefore also be controlled so as to regulate the speed of the internal combustion engine 12 so to speak by the back door, that is to say to assist in braking or accelerating the crankshaft of the engine 12 via the transmission 20, the engaged clutch 16 and the shaft 14, just prior to the engagement of a new gear. Even in pure combustion engine mode, when manually shifting the gear, the electronic control unit 34 may be configured to instantaneously bring the input shafts 18, 30 to become essentially torque-free by increasing the rotational speed thereof or braking them. The braking function of the electric motor 28 is activated by reversing the direction of the current fed to the motor.

What is claimed is:

1. Hybrid drive unit intended for a motor vehicle, comprising:
a prime mover in the form of an internal combustion engine having an output shaft coupled to a crankshaft of the engine;
a transmission manually operated by a gear shift device;
a manual clutch that can be engaged and disengaged, connected to the output shaft from the internal combustion engine, and to a first input shaft of at least one secondary drive motor in the form of an electric motor, connected to a second input shaft of the transmission and driveable from a chargeable electrical voltage source; and
an electronic control unit connected to the electric motor, the hybrid drive unit having three selectable operating modes for propelling the vehicle forwards, i.e. a first mode operating solely with the internal combustion engine, a second mode with combined hybrid operation using the internal combustion engine and the electric motor, and a third mode operating solely with the electric motor, the electric motor in the first operating mode being useable as a generator for charging the electrical voltage source, wherein all said operating modes the electronic control unit is designed, when upshifting and downshifting by means of the gear shift device, to instantaneously make the second input shaft essentially torque-free by controlling the electric motor to brake and accelerate, respectively, the second input shaft to a rotational speed suited to a higher and a lower gear, respectively, prior to active engagement of the relevant gear.

2. Hybrid drive unit according to claim 1, wherein the first and second input shafts of the transmission are formed by a first and second end respectively of a common main shaft of the transmission.

3. Hybrid drive unit according to claim 1, wherein the electric motor is configured as a disk-shaped compact electric motor directly connected to the second input shaft of the transmission.

4. Method of controlling a gear shift sequence in a manual shift transmission in a hybrid drive unit, in which the latter comprises:
a prime mover in the form of an internal combustion engine having an output shaft coupled to the manually operated transmission;
a manual clutch that can be engaged and disengaged, connected to the output shaft from the internal combustion engine, and to a first input shaft of the transmission; and
at least one secondary drive motor in the form of an electric motor, which is connected to a second input shaft of the transmission and is driveable from a chargeable electrical voltage source,
wherein the operating modes electric motor operation, combined operation of the internal combustion engine and the electric motor, and combustion engine operation, when upshifting and downshifting the transmission, the second input shaft is caused, without use of a clutch between the electric motor and the transmission, to instantaneously become essentially torque-free in that the electric motor is controlled to brake and accelerate, respectively, the second input shaft to a rotational speed suited to a higher and lower gear prior to active engagement of the relevant gear.

5. Method according to claim 4, wherein combined operation of the internal combustion engine and the electric motor, when upshifting and downshifting the transmission, the electric motor is made, via the second and first input shafts, the engaged clutch and the output shaft, also to exercise a brake action on or an acceleration of the crankshaft of the internal combustion engine to a rotational speed suited to a higher and lower gear, respectively, so that the crankshaft is kept essentially torque-free just prior to active engagement of the relevant gear.

6. Method according to claim 5, wherein the braking of the second input shaft or the crankshaft is achieved through a reversal of the direction of the current fed to the electric motor.

7. The method according to claim 5, wherein the acceleration of the second input shaft or the crankshaft is achieved through an increased current supply to the electric motor.
